(19) United States
(12) Patent Application Publication
(10) Pub. No.: US 2008/0303692 A1
(43) Pub. Date: Dec. 11, 2008

(54) Method and System for Assigning Identity Addresses to Local Management Modules

(76) Inventor: TOMONORI HIRAI, Fremont, CA (US)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/760,042

(22) Filed: Jun. 8, 2007

(51) Int. Cl. H02J 13/00; H04Q 5/22

(52) U.S. Cl. 340/825.52; 340/10.34

(57) ABSTRACT

A system and a method are provided for assigning plural identity addresses in sequence from a central management module to plural corresponding local management modules. A standby power is input to a current one of the local management modules. And the standby power towards a next un-actuated one of the local management modules is delayed for a delay period. Thus, the current one of the local management modules is allowed negotiating for assigning a dedicated one of the identity addresses.

### FIELD OF THE INVENTION

The present invention relates to a method and a system for assigning identity addresses for local management modules.

### RELATED ART IN BACKGROUND

To reduce and/or remedy component failures and malfunctions, some computer systems embed built-in management features, such as a baseboard management controller (BMC), to monitor/control system statuses and operation performance. The BMC collects operating parameters such as temperature, cooling fan speeds, power mode, operating system (OS) status, etc. and sends alerts to an administrator or a remote host if any of the parameters indicates a potential failure of the system. The administrator can also remotely communicate with the BMC to take some corrective action through remote management links, generally IPMI (Intelligent Platform Management Interface)-based links. These abilities can save on the total system maintenance cost.

Modular computer applications that have plural computer nodes or mother boards in a single chassis, such as blade or small cluster systems, may possibly need dedicated local BMCs to monitor/control each of the computer nodes or mother boards. A BMC-based central management module is quite useful for managing all local BMCs involved in the whole chassis.

When there is more than one local BMC in a system/chassis, each local BMC needs a unique ID (identity address) such as slave address for communicating with the central management module. However, the slave addresses of all local BMCs are identical by default. In order to facilitate communication between the central management module and the local BMCs, customized design is usually used in the prior art. For example, an ID register may be used to define a dedicated ID for the local BMC through hard-wired signals from essential circuit(s), only generally a standard BMC module does not have relevant component(s) or circuit(s) to provide such functions. If the system designer intends to assign unique IDs to the local BMCs without hardware changes made on standard BMC module, seeking for other solutions will be inevitable.

### SUMMARY OF THE INVENTION

Accordingly, the present invention provides a more flexible and scalable system with a relevant method for assigning plural unique identity addresses in sequence.

In one embodiment of the present invention, a system is provided for assigning identity addresses in sequence from a central management module to each of local management modules. The system includes plural local management modules, a central management module, a management bus and a standby power-up control module. The local management modules are actuated in sequence by a standby power; each of the local management modules negotiates for a dedicated one of the identity addresses respectively when actuated. The central management module assigns the dedicated one of the identity addresses to each of the local management modules respectively. The management bus allows communication between the central management module and each of the local management modules. And the standby power-up control module delays the standby power towards a next un-actuated one of the local management modules for a delay period, thereby allowing a current one of the local management modules negotiating with the central management module for assigning the dedicated one of the identity addresses.

In another embodiment, a method according to the present invention is provided for assigning identity addresses in sequence from a central management module to each of local management modules. The method includes (a) inputting a standby power to a current local management module; (b) delaying the standby power towards a next un-actuated local management module for a delay period; and (c) negotiating for assigning a dedicated identity address.

In another embodiment, a method according to the present invention is provided for assigning identity addresses in sequence from a central management module to each of local management modules. The method includes inputting a standby power to a current local management module, with the standby power towards a next un-actuated one of the local management modules being delayed for a delay period, to allow the current one of the local management modules negotiating for assigning a dedicated one of the identity addresses.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A is a block diagram of a system for assigning different identity addresses according to an embodiment of the present invention;

FIG. 1B illustrates an explanatory diagram of a standby power-up sequence defined by the standby power-up control device in FIG. 1A

FIG. 1C is a block diagram of a request message sent from the local BMC to the central management module according to the embodiment disclosed in FIGS. 1A and 1B;

FIG. 1D is a block diagram of a response message sent from a central management module to the local BMC according to the embodiment disclosed in FIGS. 1A and 1B;

FIG. 2A is a block diagram of a system for assigning different identity addresses according to another embodiment of the present invention;

FIG. 2B illustrates an explanatory diagram of a standby power-up sequence defined by the standby power-up control device in FIG. 2A; and

FIG. 3 is a block diagram of a system for assigning different identity addresses according to another embodiment of the present invention;

FIG. 4 is a flow chart of a method of respectively assigning the different identity addresses to the local BMCs disclosed in the above embodiments of the present invention.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description refers to the same or the like parts.

The present invention discloses a system and a method for assigning plural unique identity addresses to plural local management module, such as BMC (Baseboard Management Controller) modules respectively. As those skilled in this art are well known, the local management module manages the interface between system management software and platform hardware. Physical interfaces to a standard BMC module may include system management buses compatible with SMBus, RS-232 bus, address and data lines, and other IPMI-based management bus (such as Intelligent Platform Management Bus, IPMB), that enables the BMC to accept Intelligent Platform Management Interface (IPMI) request messages from other management controllers in the system. Basically, the present invention intends to assign the identity addresses of the local management modules one by one. Since all BMCs are actuated by standby power, a determinable standby power-up sequence for the local BMCs needs to be defined by hardware and/or software means.

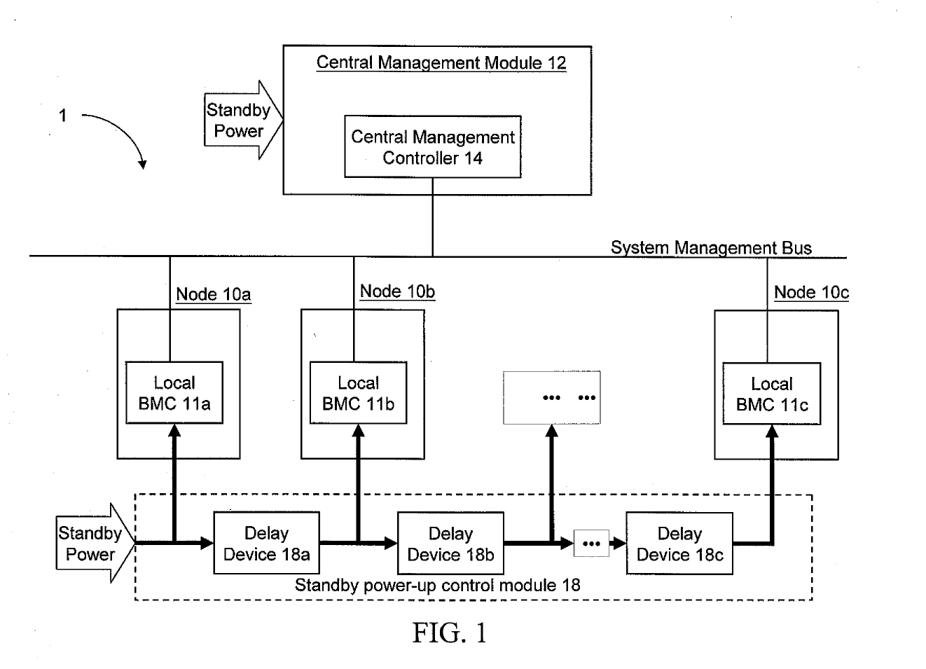

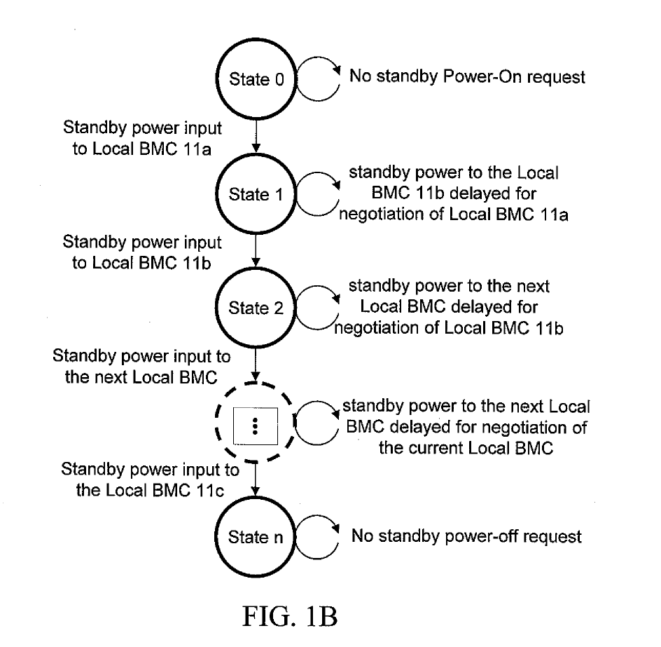

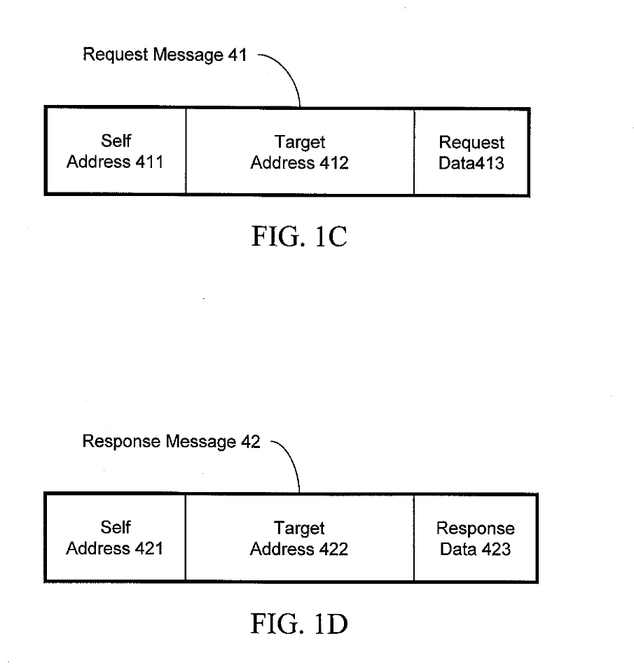

As showing in FIG. 1, according to this invention, the system 1 includes a central management module 12 that has a central management controller 14 thereon, and plural local BMCs (i.e. used as local management modules) 10a-10c that have BMC 11a-11c configured thereon respectively. The central management controller 14 may be realized by a service processor, a BMC, a SMC (satellite management controller) or other type of local management module. Similarly, the local BMCs disclosed in the present invention may be replaced by any other suitable local management modules, such as SMC, or, in some cases, a keyboard controller integrated with remote control features.

A standby power-up control module 18 is provided with the standby power and connected electrically with each of the local BMCs 10a-10c, thereby delaying the standby power to actuate the local BMC 11a, 10b, and 10c in sequence according to a predetermined standby power-up sequence, as shown in FIG. 1B. Basically, following the standby power-up sequence, when a current local BMC (the local BMC 11a for example) is negotiating for a dedicated identity address, the standby power towards the next local BMC (for example, the local BMC 11b) will be delayed for a delay period by the standby power-up control module 18. In FIG. 1, the standby power-up control module 18 includes plural delay devices 18a, 18b . . . 18c, configured in series and control the inputs of the standby power towards the local BMC 11a, 10b, and 10c respectively. Each of the delay devices 18a, 18b . . . , and 18c delays the standby power towards the next local BMC(s) for said delay period before the negotiation of the current local BMC is done. The delay device 18a, 18b . . . 18c may be realized by any delay circuits or delay components that are well known for those skilled in computer art.

Please refer to FIG. 1B, which illustrates a standby power-up sequence defined by the standby power-up control device in FIG. 1A. When the computer system connects with AC power, a standby power-on request may be sent to a power integrated circuit (not shown) and provide a DC standby power by power supply(ies) (not shown). The standby power will be input to the local BMC 11a directly and the standby power-up sequence now transfers from state 0 to state 1. At state 1, the standby power towards the local BMC 11b is held or delayed for the negotiation of the local BMC 11a. The negotiation process of the local BMC 11a is to negotiate with the central management module 12 for assigning a dedicated identity address to the local BMC 11a. The delayed duration is namely said delay period and the negotiation process will determine how long the delay period is. For different local BMCs in the present invention, the actually delay periods may possibly be different.

When the negotiation of the local BMC 11a is done, i.e. the local BMC 11a is assigned with the identity address to replace the default address, the delay device 18a will allow the standby power inputting to the local BMC 11b. Now the sequence is at state 2. Although the local BMC 11b has the same default address as the local BMC 11a, actuating the local BMC 11b will not cause address conflict. It is because during the whole sequence, only one local BMC with the default address is actuated for one time. When the later local BMC is actuated, the former local BMC has been assigned with the identity address already and no longer uses the original default address. Therefore, according to the present invention, the local BMCs must be actuated in sequence, namely, actuated one by one.

Please also refer to FIG. 1C. When any one of the local BMCs 11a, 11b, or 11c is actuated by the standby power, a negotiation between the central management module 12 and the local BMCs 11a-11c starts. For example, when the local BMC ha is first actuated, the local BMC 11a sends a request message 41 (shown in FIG. 1C) to the central management module 12. The request message 41 sent by the local BMC 11a, for example, may comprise a self address 411, a target address 412 and a request data 413. The self address 411 of the request message 41 is the default Address of local BMC 11a. Although all the local BMCs has the same default address, other local BMC will be able to influence the negotiation between the central management module 12 and the local BMC 11a. It is because all other local BMCs are not provided with the standby power and not actuated yet. The target address 412 will be the preset identity address of the central management controller 14. The request data 413 will basically be a request for assigning an identity address to the requesting local BMC 11a.

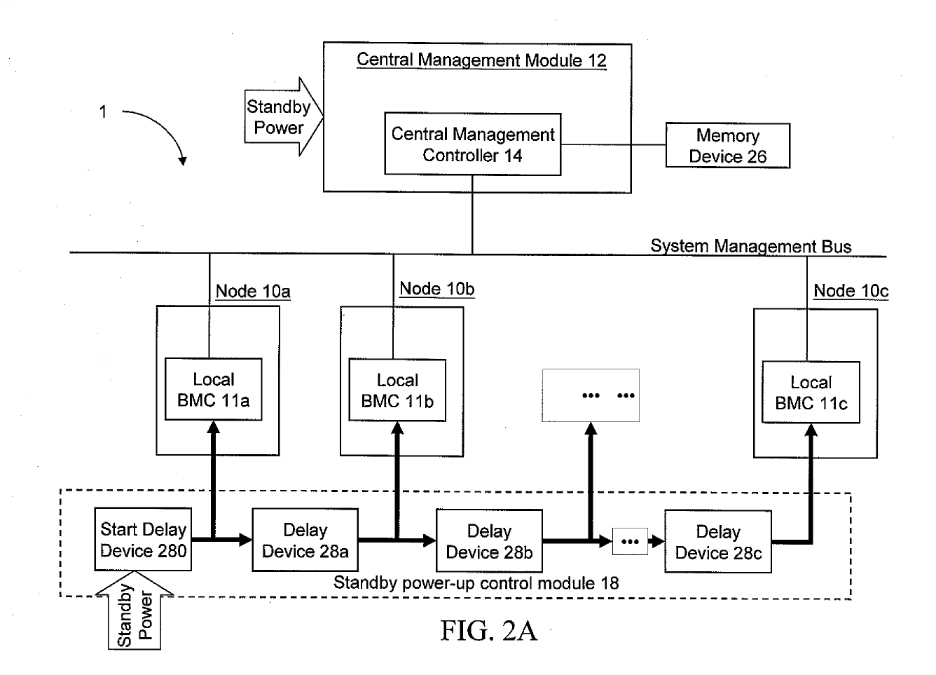

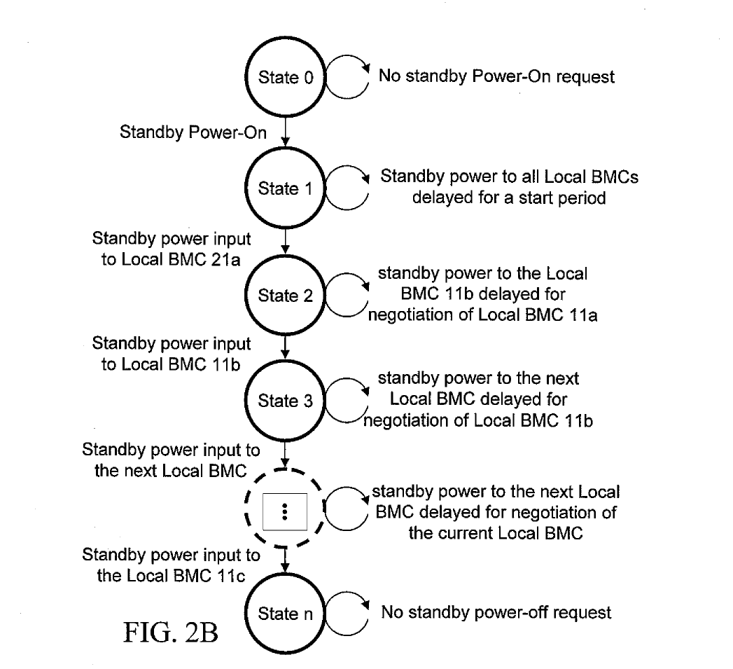

Referring to FIGS. 1A, 1B and FIG. 1D, after receiving the request 41, according to the self address 411, the target address 412 and the request data 413 of the request message 41, the central management module 12 then assigns one unique identity address and sends a response message 42 back to the local BMC 11a. For example, plural identity addresses can be stored in a memory device inside (not shown) or outside (as shown in FIG. 2A) the central management module 12. The response message 42 may have similar format as the request message. It mainly includes a self address 421, a target address 422 and a response data 423. The self address 421 of the response message 42 will be the identity address of the central management controller 14. The target address 422 will still be the default address of the local BMC 11a. And the response data 423 will be the assigned identity address for the local BMC 11a. After the local BMC 11a receives the response message 42, it will update from its default address to the assigned identity address. The assigned identity address of the requesting local BMC 11a may now be used for IPMI communication with the central management module 12. In another embodiment, the central management module 12 may comprise a firmware to perform generating the identity addresses or accessing from the memory device for each local BMC 11a-11c respectively.

Please refer to FIG. 2A. The system 2 has similar architecture as the system 1 in FIG. 1A. The differences are about a memory device 26 and the standby power-up control module 28 in FIG. 2A. The memory device 26 connected with the central management module 22 mainly stores plural identity addresses for every local BMC 21a, 21b . . . , 21c. Except delay devices 28a, 28b . . . 28c, the standby power-up control module 28 further includes a start delay device 280 may also be configured between the standby power and the first local BMC 21a. The start delay device 280 delays the standby power towards the local BMC 21a for a start period to perform some system settings and initialization processes, including actuating the central management module. The start delay device 280 may be realized by common delay circuit or delay components.

Referring to FIG. 2B which illustrates a standby power-up sequence defined by the standby power-up control device in FIG. 2A, the difference of the two sequences between FIGS. 1B and 2B is at the early stage the local BMC 21a is not directly input with the standby power. In the standby power-up sequence of FIG. 2B, the standby power may be first provided to actuate the central management module 22 and initialize some system settings in the duration of the start period. Meanwhile, the local BMC 21a will be delayed to receive the standby power until the central management module 22 is actuated and/or all system settings are done. The rest of processes in the sequence of FIG. 2B is the same as FIG. 1B.

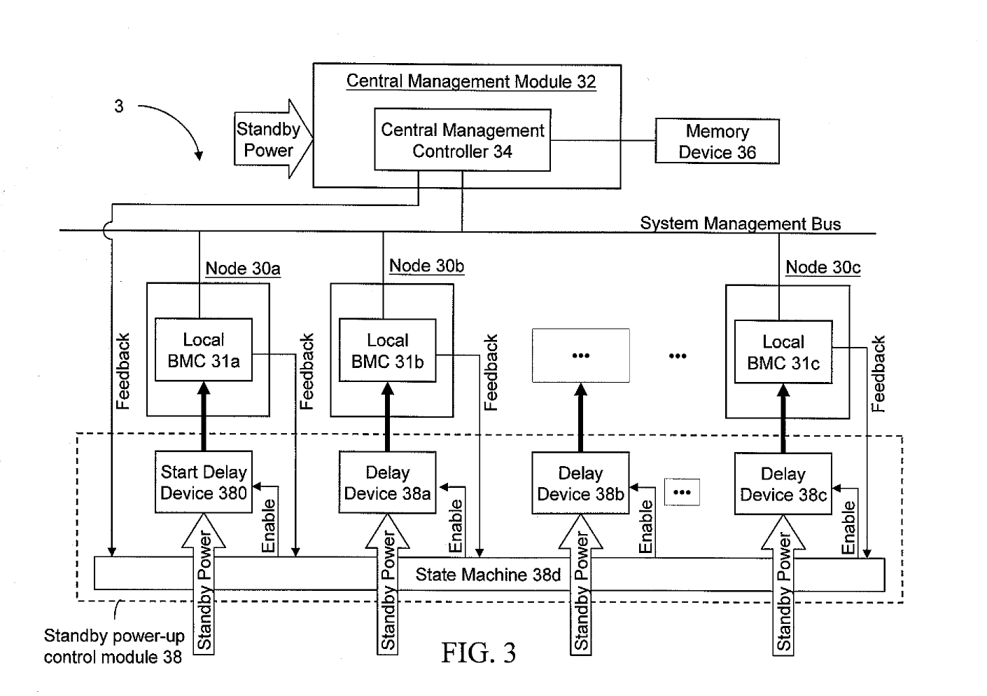

FIG. 3 illustrates a block diagram of a system for assigning different identity addresses according to another embodiment of the present invention. The system 3 has similar architecture as the system 2 in FIG. 2A. The main difference is about the standby power-up control module 38 in FIG. 3. In FIGS. 1A and 2A, the delay devices (plus the start delay device) are configured in series and the standby power only inputs to the first delay device or the start delay device. In FIG. 3, every delay device 38a, 38b . . . , or 38c or the start delay device 380 is independent from each other. The standby power directly input to each of the delay devices 38a, 38b . . . , 38c or the start delay device 380. Therefore, the standby power-up control module 38 further includes a state machine 38d to define and control the standby power-up sequence. The standby power-up sequence of the local BMCs 31a, 31b . . . , 31c will remain the same as in FIG. 2B, only the control mechanism is different. The state machine 38d basically receives feedback signals from the central management module 32 and the local BMCs 31a, 31b . . . 31c. These feedback signals will notice that the central management module 32 is actuated or the local BMCs 31a, 31b . . . , 31c have received and updated the identity addresses. The state machine 38d will enable the delay device 38a, 38b . . . , or 38c or the start delay device 380 according to these feedback signals from the central management module 32 and the local BMCs 31a, 31b . . . , 31c to allow the standby power inputting to the local BMCs 31a, 31b . . . , and 31c. A common state machine usually includes state monitor circuit(s) and memory unit(s) (both not shown) to record the current state of standby power-up sequence. A CPLD (Complex Programmable Logic Device), SPLD (Simple Programmable Logic Device) or FPGA (Field Programmable Gate Array) may be used to realize such state machine in an integrated device. Certain combination of on-board monitor circuits and essential components may operate as the state machine as well.

This invention is also to provide a method for assigning unique identity addresses to local management modules respectively. Basically, the method assigns plural identity addresses in sequence to plural local management modules. The method is mainly to input a standby power to a current one of the local management modules, with the standby power towards a next un-actuated one of the local management modules being delayed for a delay period, thereby allows the current one of the local management modules negotiating for assigning a dedicated one of the identity addresses.

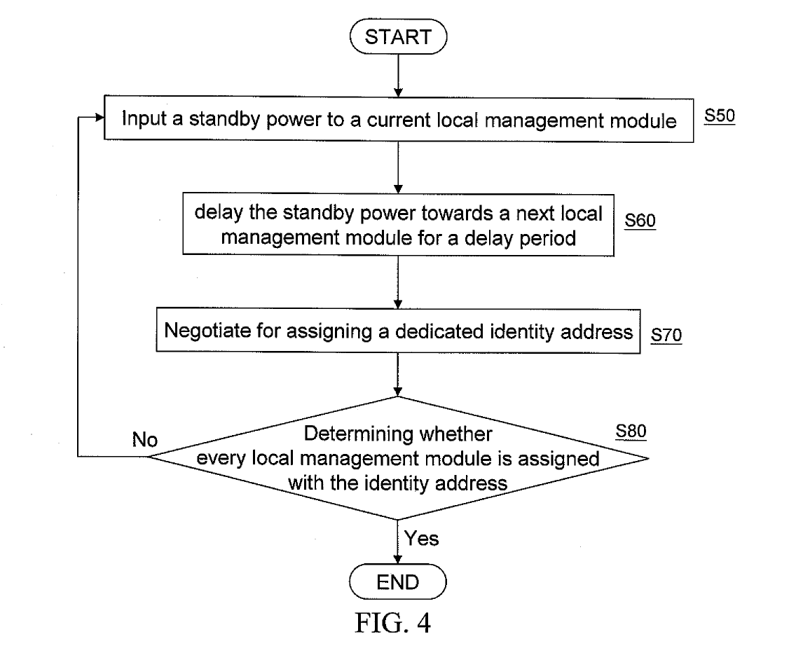

Referring to the FIG. 4, which shows a flow diagram according to the above embodiments, for example. In step S50, a standby power is input to a current local management module. Please also refer back to FIGS. 1A, 1B, 2A, 2B and 3. The current local management module is the local management module that has not been assigned with the identity address yet but is input with the standby power. Afterwards, or performed at the same time as step S50, the standby power towards a next un-actuated local management module is delayed for a delay period in step S60. Then, at the same time as the step S60 or afterwards, in step S70 the current local management takes the delay period to negotiate with the central management module for assigning a dedicated identity address to the current local management module. For the central management module of the present invention that has a firmware for generating identity addresses, the negotiation process may further includes the following steps: (1) send a request message with a default address of the current local management module, from the current management module to the central management module; (2) generate an identity address dedicated for the current local management module; and (3) send a response message with the assigned identity address, from the central management module to the current local management modules. The formats of the request message and the response message are as disclosed in FIGS. 1C and 1D. For the central management module of the present invention that connects with a memory device that stores plural identity addresses therein, said step (2) should be modified as: access a memory device and obtain an identity address dedicated for the current local management module.

Next, after the negotiation process, in step S80 the system needs to determine whether every local management module is assigned with the identity address. If “yes”, the assigning tasks are completed; if “No”, the system needs to go back to the step S50 and begins next cycle. In the next cycle, the next un-actuated local management module of the last cycle will become the current local management module in the current cycle. Namely, the standby power will be input to the next un-actuated local management module of the last cycle. Meanwhile, the next-next one of the last cycle will become the next un-actuated one in the current cycle.

For the start delay device 280/380 in FIG. 2A/3, the method may further include a step before the step S50. It is to delay the standby power towards all the local management modules for a start period. In the start period, since all the local management modules are at OFF state without providing the standby power, the central management module may first be actuated and some system settings may be completed in advance.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for assigning a plurality of different identity addresses, the system comprising:
a plurality of local management modules being actuated in sequence by a standby power, each of the local management modules negotiating for a dedicated one of the identity addresses respectively when actuated;
a central management module assigning the dedicated one of the identity addresses to each of the local management modules respectively;
at least one management bus allowing communication between the central management module and each of the local management modules; and
a standby power-up control module delaying the standby power towards a next un-actuated one of the local management modules for a delay period, thereby allowing a current one of the local management modules negotiating with the central management module for assigning the dedicated one of the identity addresses.

2. The system of claim 1, wherein the local management modules are actuated by the standby power according to a standby power-up sequence defined by the standby power-up control module.

3. The system of claim 1, wherein the standby power-up control module comprises a plurality of delay devices, each of the delay devices controlling the input of the standby power towards one of the local management modules.

4. The system of claim 3, wherein the delay devices are configured in series with the standby power directly inputting to only a first one of the local management modules.

5. The system of claim 3, wherein each of the delay devices is configured independently from each other, the standby power directly inputting to each of the delay devices.

6. The system of claim 5, wherein the standby power-up control module further comprises a state machine that enables the delay devices to allow the standby power inputting to the local management modules in sequence.

7. The system of claim 1, wherein the standby power-up control module further comprises a start delay device to control a direct input of the standby power towards a first one of the local management modules.

8. The system of claim 7, wherein the start delay device delays the standby power towards all the local management modules for a start period.

9. The system of claim 1 further comprising a memory device connected with the central management module for storing the identity addresses.

10. The system of claim 1, wherein each of the local management modules uses a default address to negotiate with the central management module when actuated.

11. A method for assigning a plurality of identity addresses from a central management module to a plurality of local management modules respectively, the method comprising:
(a) inputting a standby power to a current one of the local management modules;
(b) delaying the standby power towards a next un-actuated one of the local management modules for a delay period; and
(c) negotiating for assigning a dedicated one of the identity addresses.

12. The method of claim 11, wherein the standby power is input to each of the local management modules in sequence according to a standby power-up sequence.

13. The method of claim 11 further comprising a step of determining whether each of the local management modules is actuated, the method restarting if any of the local management modules being not actuated.

14. The method of claim 11 further comprising a step of determining whether each of the local management modules is assigned with a dedicated one of the identity addresses, the method restarting if any of the local management modules being not assigned with the dedicated one of the identity addresses.

15. The method of claim 11, wherein the negotiating step (c) further comprises the steps of:
sending a request message with a default address of the current one of the local management modules, from the current one of the local management modules to the central management module;
generating a dedicated one of the identity addresses for the current one of the local management modules; and
sending a response message with the assigned dedicated one of identity addresses, from the central management module to the current one of the local management modules.

16. The method of claim 11, wherein the negotiating step (c) further comprises the steps of:
sending a request message with a default address of the current one of the local management modules, from the current one of the local management modules to the central management module;
accessing a memory device and obtain a dedicated one of the identity addresses for the current one of the local management modules; and
sending a response message with the assigned dedicated one of identity addresses, from the central management module to the current one of the local management modules.

17. The method of claim 11 further comprising a prior step of delaying the standby power towards all the local management modules for a start period.

18. A method for assigning a plurality of identity addresses in sequence from a central management module to a plurality of local management modules, the method comprising inputting a standby power to a current one of the local management modules, with the standby power towards a next un-actuated one of the local management modules being delayed for a delay period, to allow the current one of the local management modules negotiating for assigning a dedicated one of the identity addresses.

19. The method of claim 18, wherein the standby power is input to each of the local management modules in sequence according to a standby power-up sequence.

20. The method of claim 18, wherein each of the local management modules uses a default address to negotiate with the central management module respectively.
